(19) United States
(12) Patent Application Publication
(10) Pub. No.: US 2002/0104473 A1
(43) Pub. Date: Aug. 8, 2002

(54) Magnetic bookmark

(76) Inventor: Tamie K. Smith, Temecula, CA (US)

Correspondence Address: George W. Dishong Esq., DISHONG LAW OFFICE, 40 Bryant road, Jaffrey, NH, 03452, US

(21) Appl. No.: 10/109,497

(22) Filed: Mar. 28, 2002

Related U.S. Application Data
(63) Continuation of application No. 09/507,295, filed on Feb. 18, 2000, now Pat. No. 6,401,649.
(60) Provisional application No. 60/121,083, filed on Feb. 19, 1999.

(51) Int. Cl. B42D 9/00

(52) U.S. Cl. 116/234

(57) ABSTRACT

A magnetic placemarker that remains in place and retains its shape regardless of the orientation of the document, where multiple pages are to be marked, where a place on the page is to be marked, or where the adhesive properties of the marker are to remain stable, among other things. The placemarker is of flexible but structurally sturdy material such that adornments servings as indicia can be affixed to outside surfaces of the placemarker.

CROSS-REFERENCE TO RELATED APPLICATIONS

This application claims the benefit of Provisional Application Ser. No. 60/121,083 filed on Feb. 19, 1999, entitled MAGNETIC BOOKMARK, and is a continuation of pending Utility Patent Application Ser. No. 09/507,295.

### STATEMENT REGARDING REDERALLY SPONSORED RESEARCH OR DEVELOPMENT

Not Applicable.

### BACKGROUND OF THE INVENTION

This invention most generally relates to a magnetic device that can be used to mark places in books, magazines, newspapers, among other documents. More particularly the invention relates to placemarkers that adhere through magnetism, and are adorned with indicia.

Presently, inventions exist for placemarkers that protrude from the edge of the document, mark multiple places, mark multiple pages, and can be secured to the book. These inventions solve particular problems such as creating thumb tabs on document edges, accommodating readers who require multiple marks in the same document, and insuring that the bookmark does not fall out of the book.

U.S. Pat. No. 2,448,611 (Martin) discloses a magnetic bookmark in which a strip of flexible material such as cloth or paper is folded in half, adhesive is added to the ends of the material, and magnets are placed on the adhesive. The ends are folded over on top of the magnets. Because the cloth or paper does not itself have the structural integrity to retain its shape during use, a second shorter strip is secured to the main strip and folded at or near the point of attachment. Martin confines the opposing magnets to the ends of the main strip and does not mention the addition of indicia such as buttons, pins, pictures, or other indicia that would make the flexible material of Martin unsuitable for its intended use as a bookmark with opposing magnets on the ends.

What is needed is a placemarker that holds its shape when adorned with indicia of substance. Also, what is needed is a magnetic placemarker that can be folded in any way, not confined to a mid-point fold in order to insure the alignment of opposing magnets.

### SUMMARY OF THE INVENTION

The problems set forth above as well as further and other problems are solved by the present invention. The solutions and advantages of the present invention are achieved by the illustrative embodiment of the present invention described hereinbelow.

A placemarker that stays in place through magnetic force, holds it shape during use, and is rigid enough to host indicia with independent structure is disclosed. The placemarker of the present invention includes a semi-flexible substrate having a first surface and an opposing second surface. The substrate can take any shape including, but not limited to, polygonal, arcuate, irregular, symbolic, animal, character, or plant. For example, the substrate could take the shape of a rectangle that is folded at its lengthwise one-third/two-thirds point, where one-third of the substrate could fold over a first side of a page, which two-thirds of the substrate could fold over a second side of the page and be mutually attracted through magnetism to the one-third portion folded over the first side of the page. Alternatively, and by way of example, the substrate could have the shape of two 2-dimensional baseballs hinged at an edge.

Any shape can be accomplished by cutting the substrate to the desired shape and affixing, if not already integrated, a magnetic substance to the first surface, i.e. the surface that surrounds the page when folded. The magnetic substance has a plurality of mutually attractive portions that, when placed in alignment when said substrate is folded, connect the portions to each other. The magnetic substance could include a plurality of magnets attached through adhesive to the first surface, or it could include a continuous magnetic surface attached to or integral with the first surface. Alternatively, the substrate could be a magnetic strip that, when folded, exhibits mutual attractive properties that hold the two parts of the first surface together. Portions of the magnetic substance exhibit mutual attraction when placed in alignment with each other when the substrate is folded.

The semi-flexible substrate of the placemarker of the present invention is substantial enough so that indicia having structure independent from the substrate can be attached to the substrate without compromising the shape-holding integrity of the substrate. Thus, the placemarker of the present invention includes such indicia as buttons, charms, nameplates, and other such items of substance that could be attached with adhesive or other attaching means commonly known in the art. When the placemarker is folded, the second surface, the surface upon which indicia are affixed, is visible.

A method for making a placemarker is disclosed. The method of the illustrative embodiment of the present invention includes the steps of forming a semi-flexible substrate (having first and second surfaces) to a shape, affixing indicia to the second surface of the substrate, and folding the substrate so that the second surface is visible and the first surface forms the interior of the fold. The first surface of the substrate has a first magnetic section and a second magnetic section, and the first magnetic section is mutually magnetically attractive to the second magnetic section, so that when the substrate is folded with the first surface forming the interior of the fold, opposing magnetic attraction of the first and second magnetic sections holds the placemarker folded. The indicia of the placemarker have structure independent from the substrate and thus must be affixed through adhesive or other means known in the art.

In an alternate embodiment, a placemarker removably attachable to at least one page of a document is disclosed that includes a plurality of substrates each having proximal and distal ends, each having edges defining thereby a predetermined and selected geometry whereby said selected geometry has an averaged width dimension and an averaged length dimension, and wherein each substrate is formed of a material. The placemarker of the alternate embodiment also includes a means for connecting each substrate to the plurality of each of the other substrates at proximal ends of all the substrates forming a stack of substrates having outward-facing surfaces on each of two outward-facing sides of the stack. Indicia may be placed on the outward-facing surfaces. The placemarker also includes a plurality of inward-facing surfaces on any surface of the substrate that is not an outer-facing surface. Finally, the alternate embodiment of the placemarker includes a magnet segment securely affixed to any inward-facing surface of each of the substrates at the distal ends of each of the substrates. The magnet segments are oriented to be mutually attracted when the substrates are positioned so that the inward-facing surfaces of two substrates are proximate each to the other.

The alternate embodiment of the placemarker can further include an item attached to at least one of said outward-facing surfaces of said substrates. Also, the material of the alternate embodiment of the placemarker can be selected from the group consisting of cloth, paper, paperboard, plastic, metal, metal alloys, and wood. The item of the alternate embodiment of the placemarker can be at least one selected from the group consisting of buttons, sprinkles, charms, and photos.

A process for making a removably attachable placemarker of the alternate embodiment, wherein the placemarker consists of a plurality of substrates with proximal and distal ends, each having edges defining thereby a predetermined and selected geometry whereby said selected geometry has an averaged width dimension and an averaged length dimension, comprising cutting a plurality of inner sections of the substrate to said predetermined geometric shape and predetermined area dimension forming a plurality of inner section substrates each with two surfaces, one on each side of each substrate, and each with proximal and distal ends. The process for making the placemarker of the alternate embodiment further includes securely attaching a magnet to each of the two surfaces on each distal end of each inner section substrate, wherein the magnet segments are oriented to be mutually attracted when the substrates are positioned so that the distal ends of the substrates are opposing and proximate each to the other. The process further includes cutting two outer sections of the substrate to the predetermined geometric shape and predetermined area dimension forming two outer section substrates each with an outward-facing surface and an inward-facing surface, and each with proximal and distal ends. The process further includes securely attaching a magnet segment to each of the two inward-facing surfaces of each outer section substrate on the outer section distal ends, wherein the magnet segments are oriented to be attracted to each distal end of each inner section substrate when each inward-facing surface of each outer section substrate is positioned proximate to the distal end of the inner section substrate. The process further includes connecting each of the plurality of inner section substrates to one another at proximal ends forming a stack of inner section substrates having two outer sides. The process further includes connecting one of the outer section substrates to one outer side of the stack of inner section substrates at the proximal ends of both the outer section substrate and the stack of inner section substrates, wherein the inward-facing surface faces one outer side of the stack of inner section substrates. Finally, the process includes connecting the other outer section substrate to the other outer side of the stack of inner section substrates at said proximal ends of both outer section substrate and the stack of inner section substrates, wherein said inward-facing surface faces the other outer side of the stack of inner section substrates.

The process can further include creating a design on at least one outward-facing surface by a process selected from a group consisting of stamping, embossing, and glittering. The process can further include affixing ornaments from a group consisting of buttons and charms to one outward-facing surface.

The placemarker of the present invention has the particular objective and advantage of remaining in the marked location no matter how the document is oriented, and no matter how many times the marker is used. This is because magnets, unlike adhesive or clip markers, do not lose their adhesive properties, nor stretch from use, nor vary in their ability to securely fasten after repeated use.

The placemarker of the present invention can accommodate situations where multiple marks are desired or where it is desired to mark a specific location on a page of the document. In one embodiment of the invention, the marker is constructed of a folded rectangular piece of sturdy but flexible material, on which inner sides of the folded material are affixed magnets. This embodiment of the marker can be folded over one or several pages, anywhere on the page to thus mark a specific location at which point, perhaps, reading was suspended. In another embodiment, a plurality of substrates of sturdy but flexible material are permanently or semi-permanently connected at proximal ends with each other, and onto which distal ends are affixed magnets. In pairs, these substrates can surround or be interleaved with one or several pages and be securely attached to each other, in pairs, at distal ends. Thus, the number of marks possible in this multi-substrated marker depends on the number of substrates.

For a better understanding of the present invention, together with other and further objects thereof, reference is made to the accompanying drawings and detailed description. The scope of the present invention is pointed out in the appended claims.

### BRIEF DESCRIPTION OF THE SEVERAL VIEWS OF THE DRAWING

FIG. 1 is a perspective view of the placemarker of the present invention when in use;

FIG. 2 is a perspective view of the second surface of a rectangularly-shaped illustrative embodiment of the present invention;

FIG. 3 is a perspective view of the first surface of the rectangularly-shaped illustrative embodiment of the present invention;

FIG. 4 is perspective view of the placemarker of the alternate embodiment of the present invention when in use;

FIG. 5 is a perspective view of the components of alternate embodiment of the present invention;

FIGS. 6A and 6B are perspective views of illustrative magnet placement and substrate connectivity of the alternate embodiment of the present invention;

FIGS. 7A and 7B are perspective views of a magnetic strip integrated onto the first surface and a non-mid-point fold; and

FIGS. 8A-C are perspective views of a non-rectangular substrate.

### DETAILED DESCRIPTION OF THE INVENTION

The present invention is now described more fully hereinafter with reference to the accompanying drawings, in which the illustrative embodiment of the present invention is shown.

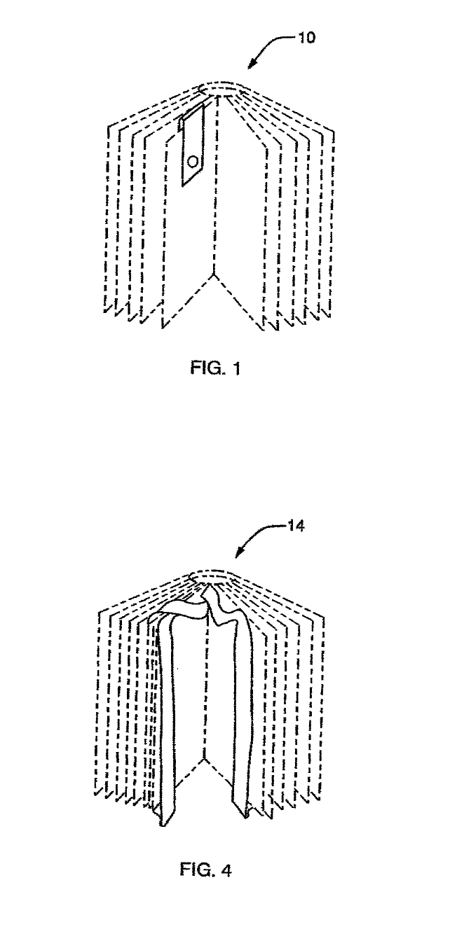

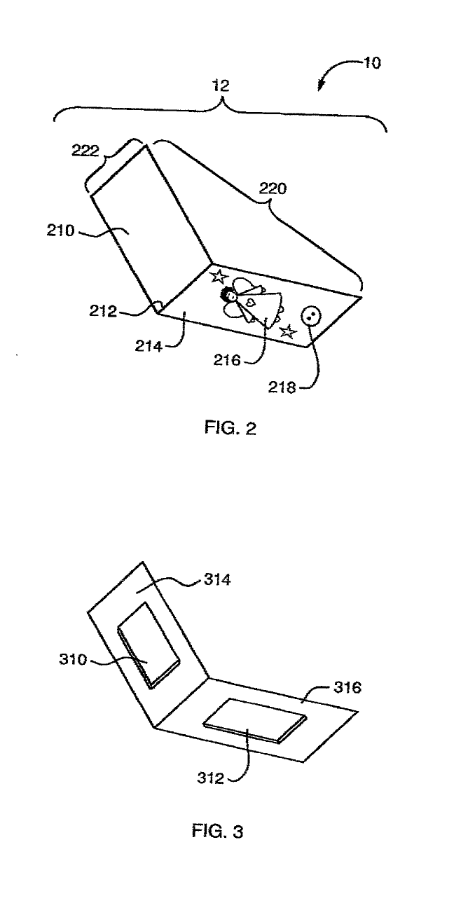

Referring to FIGS. 1, 2, and 3, embodiment 10 is a placemarker that can be removably attachable to at least one page of a document or book. The placemarker includes substrate 12 having predetermined averaged width 222 and averaged length 220 dimensions, substrate 12 being formed of a material which has outward-facing surface 214 on which indicia 216 and ornaments 218 may be placed. Substrate 12 is fabricated with a means for causing substrate 12 to be foldable, said means, in the preferred embodiment, located substantially about midpoint 212 of length dimension 220 thereby creating substrate portions 210 and 214. Magnetic segment 310 is securely affixed to inward-facing surface 314 of substrate 210, and magnetic segment 312 is securely affixed to inward-facing surface 316 of substrate 214. Magnetic segments 310 and 312 are oriented to be mutually attracted when substrate 12 is folded so that inward-facing surfaces 314 and 316 are proximate each to the other.

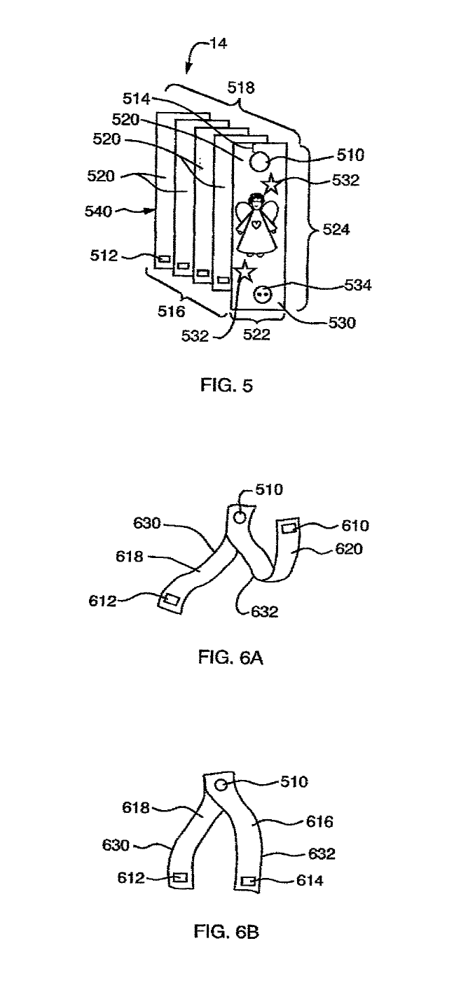

Referring to FIGS. 4, 5, and 6A-B, embodiment 14 is a placemarker that is a removably attachable plurality of substrates to mark multiple pages in a book or document. Embodiment 14 includes a plurality of substrates 520 that are fixedly, though not necessarily permanently, attached by means of attachment device 510 near proximal ends 518 a fixed distance 514 from proximal ends 518 of substrates 520. Substrates 520 have predetermined averaged width 522 and length 524 dimensions, and are formed of material that has outward-facing surfaces 616 and inward-facing surfaces 618. In the preferred embodiment, substrates 520 are stacked such that outer-most-facing surface 530 can be decorated with ornaments 534 and indicia 532. Magnet segments 610, 612, and 614 are securely affixed to opposing surfaces 618 and 620 of substrates 630 and 632. Likewise, magnet segment 614 is securely affixed to side 616 of substrate 632, if substrate 632 is not the outer-most-facing surface of the stack, such as substrate 530. Effectively, each opposing side, save out-most-facing sides 530 and 540, of substrates 520 are affixed with magnet segments, thus enabling multiple page marking shown in embodiment 14, FIG. 4.

Referring now to FIGS. 7A and 7B, a placemarker having a non-midpoint fold is shown. In FIG. 7A, the first surface of the substrate is divided in one-third/two-thirds portions, sections 701 and 703 respectively. First surface one-third section 701 is folded on fold line 702 and is sized at one-third of the total length of substrate 700. Note that the sizing of one-third is used herein for illustrative purposes only. The substrate could be folded at any point along its length or width. First surface two-thirds section 703 includes the remainder of the substrate. Referring to FIG. 7B, second surface 709 hosts independent structure indicia 705 and 707. Example indicia 705 and 707 have utility as a button (indicia 705) and star-shaped pin (indicia 707), and are herein used as adornment to second surface 709, being attached through adhesive or other known means.

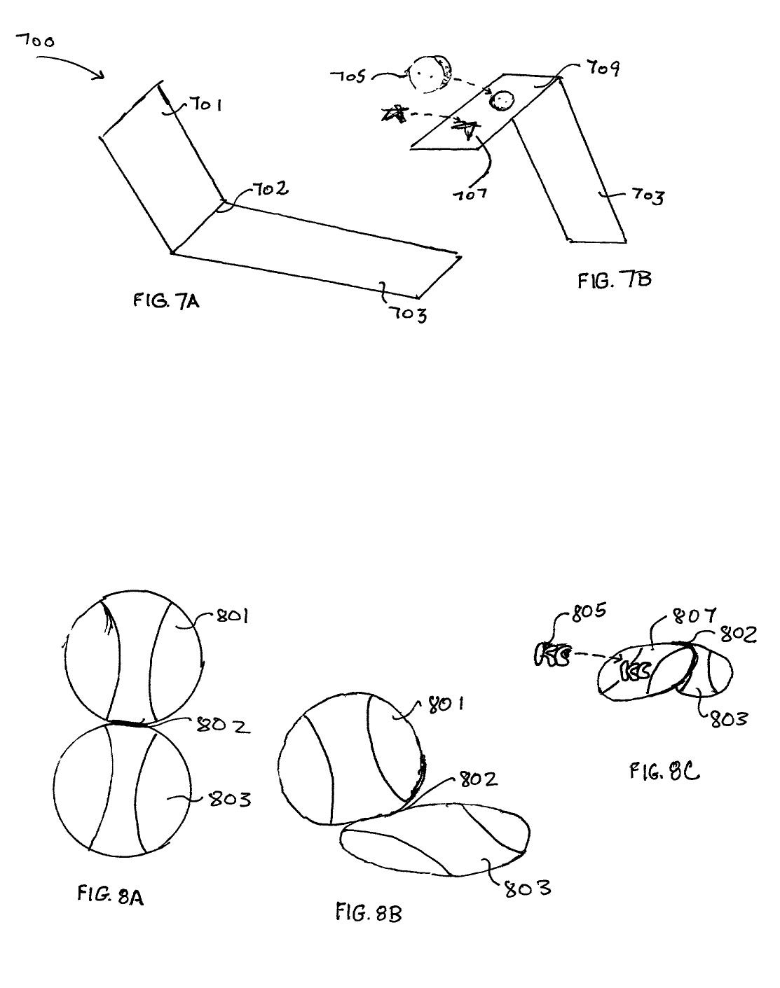

Referring now to FIGS. 8A-C, substrate 800 is formed into the shape of two baseballs. Shown in FIG. 8A-B are first surface sections 801 and 803 hinged at fold line 802. Shown in FIG. 8C are second surface 807 adorned with nameplate indicia 805, which is, in this example, a metal nameplate riveted onto second surface 807.

The material used in the construction of the illustrative and alternate embodiments can include, but is not limited to, cloth, paper, paperboard, foam, plastic, wood, or synthetics. Indicia 216, 218, 532, and 534 affixed to outward-facing surfaces 214 and 530 can include, but are not limited to, charms, buttons, nameplates, and photos.

Although the invention has been described with respect to various embodiments, it should be realized this invention is also capable of a wide variety of further and other embodiments within the spirit and scope of the appended claims.

What is claimed is:

1. A placemarker comprising:
a substrate of semi-flexible material, said substrate having a first surface and an opposing second surface; and
magnetic substance on said first surface, said magnetic substance having a plurality of mutually attractive portions enabling connection of said portions when said portions are placed in alignment when said substrate is folded.

2. The placemarker according to claim 1 further comprising at least one indicia affixed to said second surface, said indicia having structure independent from said substrate.

3. The placemarker according to claim 1 wherein said semi-flexible material is selected from the group consisting of paperboard, plastic, metals, metal alloys, and magnetic strip.

4. The placemarker according to claim 2 wherein said semi-flexible material is selected from the group consisting of paperboard, plastic, metals, metal alloys, and magnetic strip.

5. The placemarker according to claim 1 wherein said indicia are selected from the group consisting of buttons, charms, and nameplates.

6. The placemarker according to claim 2 wherein said indicia are selected from the group consisting of buttons, charms, and nameplates.

7. The placemarker according to claim 1 wherein said substrate can take a shape selected from the group consisting of polygonal, arcuate, irregular, symbols, animals, characters and plants.

8. The placemarker according to claim 2 wherein said substrate can take a shape selected from the group consisting of polygonal, arcuate, irregular, symbols, animals, characters and plants.

9. The placemarker according to claim 1 wherein said magnetic substance is selected from the group consisting of a plurality of magnets, an integrated magnetic strip, and an adhesive magnetic strip.

10. The placemarker according to claim 2 wherein said magnetic substance is selected from the group consisting of a plurality of magnets, an integrated magnetic strip, and an adhesive magnetic strip.

11. A method for making a placemarker comprising:
forming a semi-flexible substrate to a shape, said substrate having a first surface and an opposing second surface, said first surface having a first magnetic section and a second magnetic section, said first magnetic section having mutual magnetic attraction to said second magnetic section;
affixing indicia to said second surface, said indicia having structure independent from said substrate; and
folding said substrate so that said second surface is visible and said first magnetic section is aligned with said second magnetic section.
